(19) United States
(12) Patent Application Publication
(10) Pub. No.: US 2016/0142284 A1
(43) Pub. Date: May 19, 2016

(54) ESTABLISHING A MULTICAST BACKUP PATH

(71) Applicant: Cisco Technology, Inc., San Jose, CA (US)

(72) Inventor: Dan Ma, Miliptas, CA (US)

(21) Appl. No.: 14/542,783

(22) Filed: Nov. 17, 2014

(51) Int. Cl. H04L 12/707; H04L 12/18

(52) U.S. Cl. CPC H04L 45/22; H04L 12/18

(57) ABSTRACT

In one embodiment, a first device in a network determines a primary border gateway protocol (BGP) path and a secondary BGP path to a second device in the network. The first device sends requests to join a multicast label switched path (LSP) to the second device via the primary BGP path and via the secondary BGP path. The first device receives LSP traffic associated with the multicast LSP via the primary and secondary BGP paths. The first device drops the LSP traffic received via the secondary BGP path, in response to receiving the LSP traffic via the primary BGP path.

### TECHNICAL FIELD

The present disclosure relates generally to computer networks, and, more particularly, to establishing a multicast backup path.

### BACKGROUND

Multiprotocol label switching (MPLS) is a packet switching technology that allows routing decisions to he based on labels that are appended to the headers of packets. Such a label represents a path in the network and is used to make forwarding decisions until the corresponding packet reaches its destination. Once the packet reaches its destination, the destination device may pop (e.g., remove) the corresponding label from the header of the packet and/or apply another label to the packet, to continue routing the packet throughout the network.

To define a common meaning for a label throughout an MPLS network, label switched routers (LSRs) may use a label distribution protocol (LDP). For example, the LSRs may use the LDP to distribute information regarding a particular label and its associated network path. Notably, the network path represented by the label may be a single hop (e.g., to the next device) or may represent a multi-hop network path. An LDP also typically associates a forwarding equivalence class (FEC) with a given label/path. Thus, data packets that belong to the FEC are all routed in a similar manner using the appropriate label.

Multicast LDP (mLDP) includes extensions to an LDP that allows multicast LSPs to be established. For example, multicast LSPs may be point-to-multipoint (P2MP) where data sent from a single source is routed to multiple destinations. In another example, multicast LSPs may also be multipoint-to-muitipoint (MF2MP) in which data from multiple sources are routed along the paths to multiple destinations.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIGS. 3A-3D illustrate an example of devices within an MPLS network;

FIGS. 4A-4D illustrate an example of a network device switching between mLDP paths;

FIG. 5 illustrates an example simplified procedure for establishing primary and secondary network paths; and

FIG. 6 illustrates an example simplified procedure for switching network paths.

### DESCRIPTION OF EXAMPLE EMBODIMENTS

### Overview

According to one or more embodiments of the disclosure, a first device in a network determines a primary border gateway protocol (BGP) path and a secondary BGP path to a second device in the network. The first device sends requests to join a multicast label switched path (LSP) to the second device via the primary BGP path and via the secondary BGP path. The first device receives LSP traffic associated with the multicast LSP via the primary and secondary BGP paths. The first device drops the LSP traffic received via the secondary BGP path, in response to receiving the LSP traffic via the primary BGP path.

### Description

A computer network is a geographically distributed collection of nodes interconnected by communication links and segments for transporting data between end nodes, such as personal computers and workstations. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

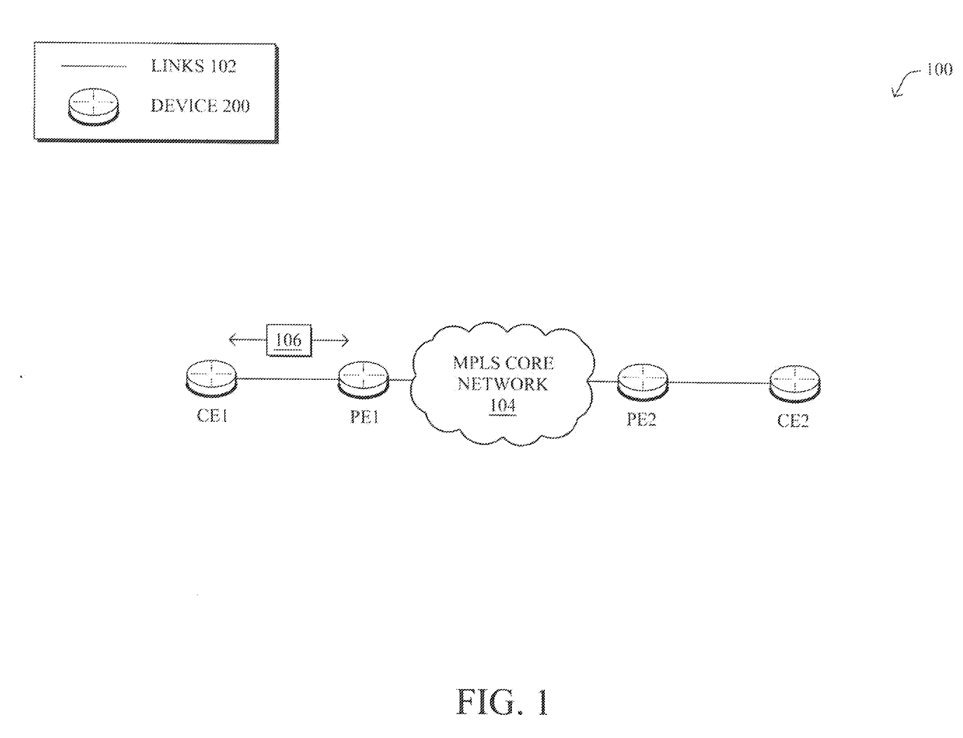

FIG. 1 is a schematic block diagram of an example computer network 100 illustratively comprising nodes/devices 200, such as a plurality of routers/devices interconnected by links or networks, as shown. For example, customer edge (CE) routers (e.g., CE1 and CE2) may be interconnected with provider edge (PE) routers (e.g., PE1 and PE2, respectively), to communicate across a core network, such as an illustrative Multi-Protocol Label Switching (MPLS) core network 104. Data packets 106 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol Frame Relay protocol, or any other suitable protocol. Those skilled in the art will understand that any number of nodes, devices, links, etc. may be used in the computer network, and that the view shown herein is for simplicity.

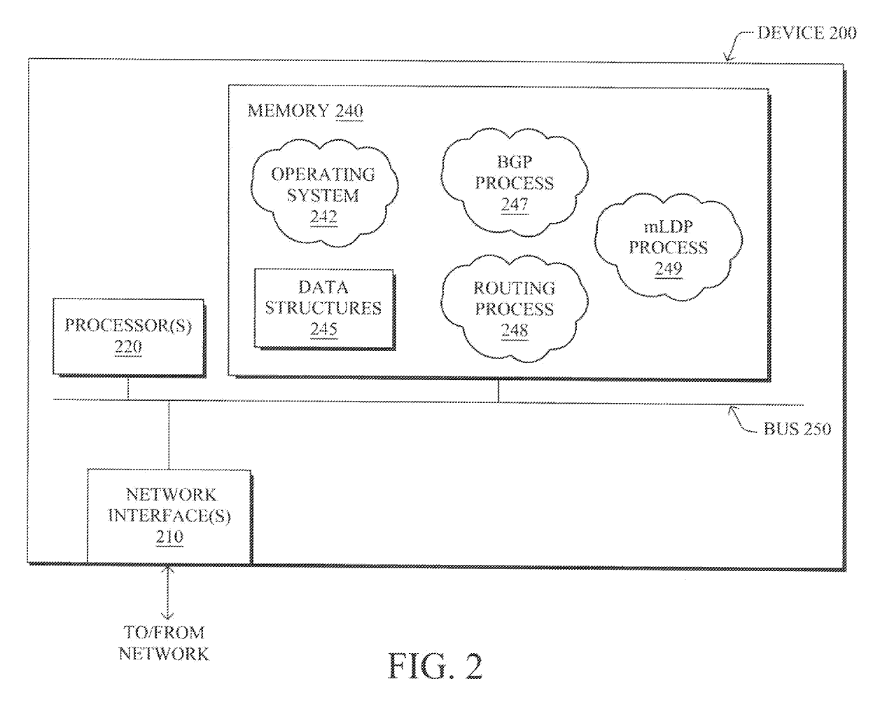

FIG. 2 is a schematic block diagram of an example node/device 200 that may be used with one or more embodiments described herein, e.g., as any of the routers of network 100, or any other computing device that supports the operations of network 100 (e.g., switches, etc.). Device 200 comprises a plurality of network interfaces 210, one or more processors 220, and a memory 240 interconnected by a system bus 250. The network interfaces 210 contain the mechanical, electrical, and signaling circuitry for communicating data over physical links coupled to the network 100. The network interfaces may be configured to transmit and/or receive data using a variety of different communication protocols. Notably, a physical network Interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processes and/or services executing on the device. These software processes and/or services may include a border gateway protocol (BGP) process 247, a routing process 248 (e.g., routing services), and/or an mLDP process 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Routing process/services 244 contain computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP) (e.g., in conjunction with BGP process 247), etc., as will be understood by those skilled in the art. These functions may be configured to manage a forwarding information database containing, e.g., data used to make forwarding decisions. In particular, changes in the network topology may be communicated among routers 200 using routing protocols, such as the conventional OSPF and IS-IS link-state protocols (e.g., to “converge” to an identical view of the network topology).

Notably, routing process 244 may also perform functions related to virtual routing protocols, such as maintaining VRF instances, or tunneling protocols, such as tor MPLS, generalized MPLS (GMPLS), etc., each as will be understood by those skilled in the art. Also, EVPN, e.g., as described in the IETF Internet Draft entitled “BGP MPLS Based Ethernet VPN” <draft-ietf-12vpn-evpn>, introduces a solution for multipoint L2VPN services, with advanced multi-homing capabilities, using BGP for distributing customer/client media access control (MAC) address reach-ability information over the core MPLS/IP network.

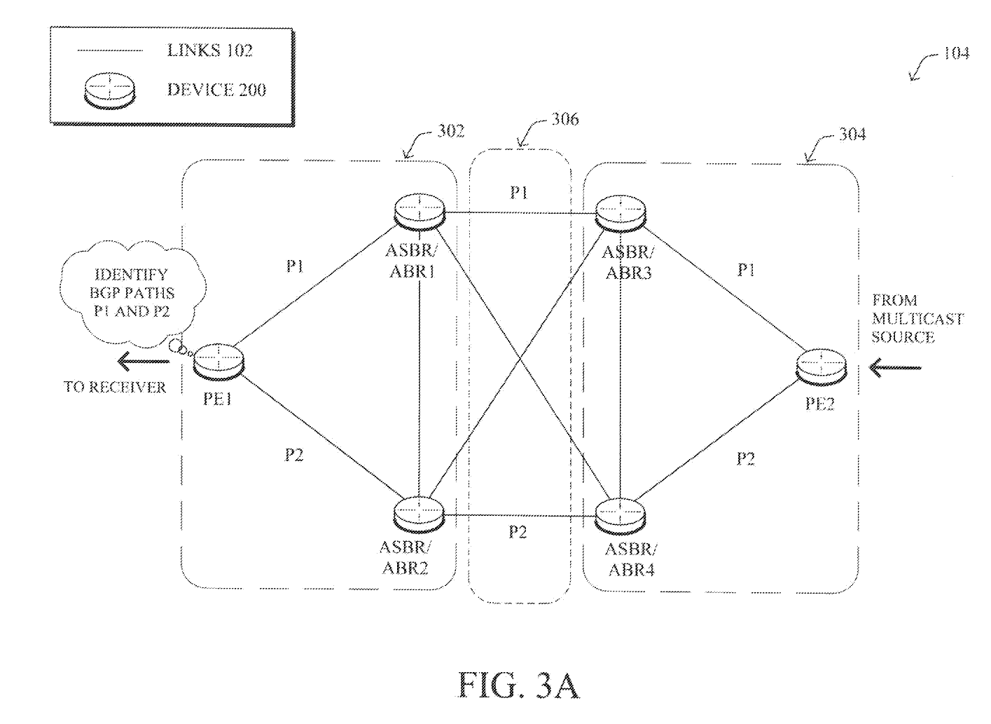

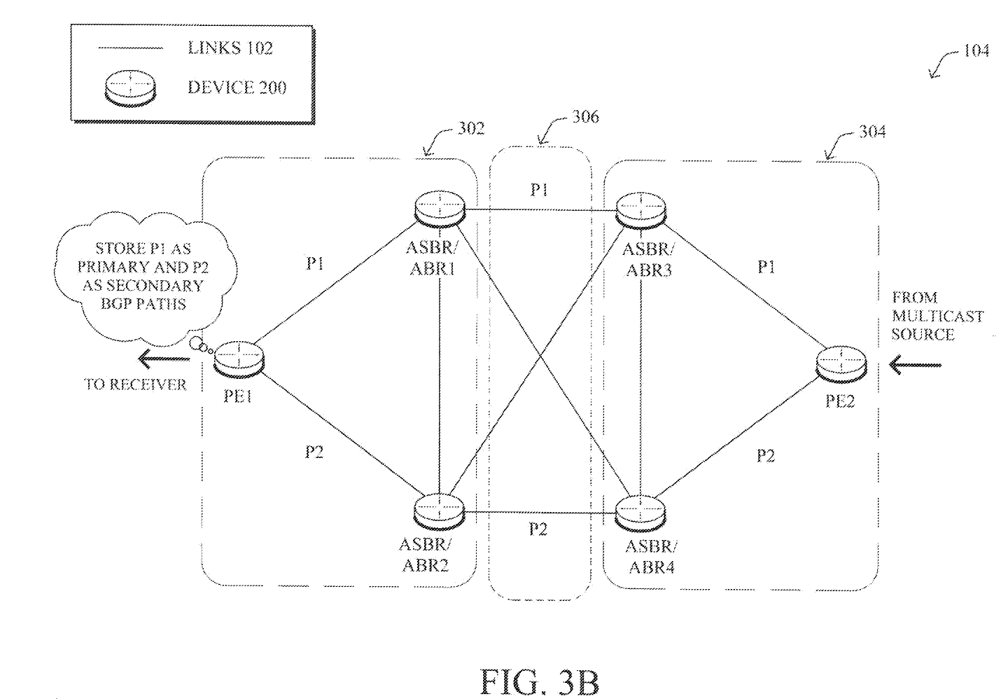

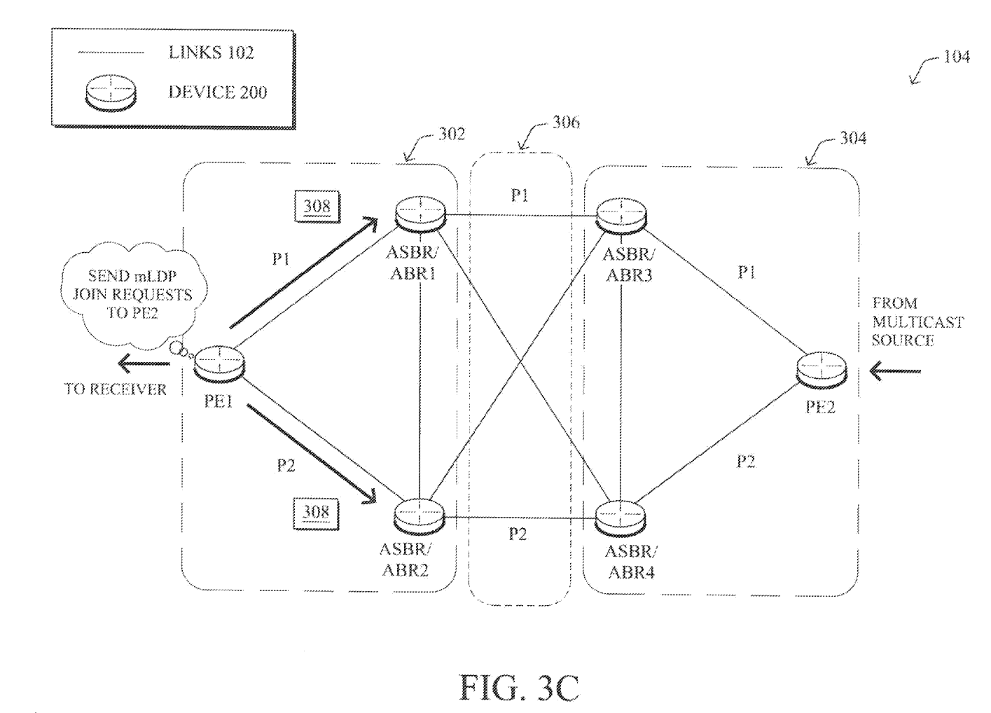

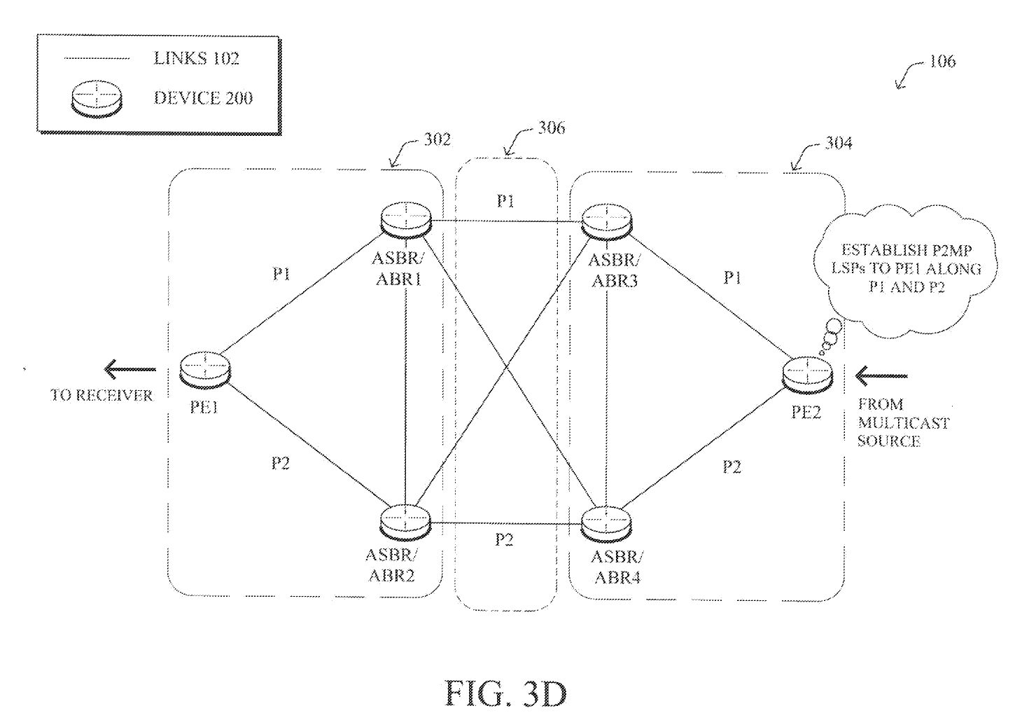

Referring now to FIGS. 3A-3D, an example of devices within an MPLS network (e.g., network 104) is shown, according to various embodiments. As shown, assume that PE1 belongs to a first routing area 302 and that PE2 belongs to a second routing area 304. In some implementations, routing areas 302,304 may be autonomous systems. In other implementations, routing areas 302,304 may be interior gateway protocol (IGP) domains that are connected by an IGP backbone domain 306. In either ease, routes between PE1 and PE2 may traverse autonomous system boundary routers (ASBRs)/area border routers (ABRs), which provide connectivity between routing areas 302, 304. As would be appreciated, any number of nodes/devices may also reside between a given PE and a given ASBR/ABR and that the simplified network layout shown is for purposes of illustration.

In some cases, a border gateway protocol (BGP) may be used to convey MPLS label information. For example, the Internet Engineering Task Force (IETF) Proposed Standard, Request tor Comment (RFC) 3107, entitled “Carrying .Label information in BGP-4” by Rekhter, et al. (May 2001), provides a mechanism whereby label mapping information may be piggybacked on BGP update messages. Typically, RFC 3107 processes are also implemented in conjunction with BGP prefix independent, convergence (PIC). In general, BGP PIC provides a mechanism whereby a single router or other routing device is configured to calculate both the best route/path, as well as a repair path. Thus, if the primary path experiences a failure, subsequent packets may be forwarded using the backup path.

In some cases, as shown, 3107 PIC may be deployed between bordering autonomous systems (e.g., areas 302, 304) using, e.g., Inter-Autonomous System (Inter-AS) Option C, which uses multi-hop eBGP VPNv4 between autonomous systems. For example, the ASBR/ABRs shown may promulgate labels in accordance with RFC 3107 using eBGP IPv4 messages with corresponding path labels.

3107 PIC may also be deployed between IGP domains. For example, as shown, assume that two IGP domains (e.g., areas 302. 304) are separated by an IGP backbone domain 306. In such a case, MPLS 3107 PIC may be deployed by using iBGP messages with path labels across IGP backbone domain 306, in accordance with RFC 3107. Such an implementation may sometimes be referred to as an Inter-IGP domain, seamless MPLS 3107 deployment.

For certain 3107 PIC MPLS deployments (e.g., using Inter-AS Option C, using Inter-IGP-domain seamless MPLS 3107 deployment, etc.), the whole network architecture will use dual ASBR/ABRs, to implement 3107 PIC. In such cases, a PE router (e.g., PE1) may use a BGP to install two BGP paths in its routing information base (RIB), to reach a remote PE router (e.g., PE2) across the Inter-AS or InterTGP network. For example, as shown in FIG. 3B, PE1 may install a primary path P1 and a backup path P2 in RIB, to reach PE2 across the network. As shown, primary path P1 may use ASBR/ABR1 loopback as a recursive next-hop (e.g., a primary recursive next hop), while backup path P2 may use ASBR/ABR2 loopback as a recursive next-hop (e.g., as a backup recursive next hop). Thus, when ASBR/ABR1 fails, the 3107 BGP PIC mechanism will be triggered/activated, allowing unicast traffic to be seamlessly rerouted (e.g., as part of a fast reroute mechanism) using the backup path P2.

Currently, when an mLDP is used in a 3107 PIC deployment (e.g., to establish a P2MP LSP), the receiver PE will only generate and send recursive FEC requests towards the source PE via the primary recursive next hop (e.g., the primary BGP path). Such requests may be used by the source PE, to construct the multicast LSP. For example, as shown in FIG. 3B, PE1 may typically only send recursive FEC requests to PE2 along primary path P1, to join the P2MP LSP sourced by PE2. Thus, the source PE2 may only establish a single LSP to receiver PE1 via the primary path P1. However, if ASBR/ABRI subsequently goes down, receiver PE1 will have no backup LSP on which to continuously receive the multicast traffic. In such a case, receiver PE1 may respond by generating a new recursive FEC request towards source PE2 along a different path, to rejoin the P2MP LSP. Consequently, the receiver PE1 will experience a period of time during which it experiences traffic loss of the multicast traffic, which can sometimes exceed 500 ms, thereby demonstrating poor convergence. If the primary recursive next hop ASBR/ABR1 then recovers, the convergence may become even worse, with a window of traffic loss potentially upwards of two seconds.

According to various techniques described herein, a network that uses mLDP and 3107 PIC may be configured to leverage information regarding the 3107 PIC backup path, as part of a multicast only fast re-route (MoFRR) mechanism. In some cases, a node/device may use the BGP PIC backup path, to establish an inactive, recursive FEC LSP with the source PE. In the case where the primary 3107 path fails, the node/device may not only switch to using the BGP backup path in its RIB/FIB, but it may also switch to using the inactive, recursive FEC LSP. As would be appreciated, such a switchover may minimize the traffic loss that results from the primary path failure, in contrast to existing techniques that would require the device to subsequently rejoin the multicast using a different path.

Specifically, according to one or more embodiments of the disclosure as described in detail below, a first device in a network determines a primary border gateway protocol (BGP) path and a secondary BGP path to a second device in the network. The first device sends requests to join a multicast label switched path (LSP) to the second device via the primary BGP path and via the secondary BGP path. The first device receives LSP traffic associated with the multicast LSP via the primary and secondary BGP paths. The first device drops the LSP traffic received via the secondary BGP path, in response to receiving the LSP traffic via the primary BGP path.

Illustratively, the techniques described herein may be performed by hardware, software, and/or firmware, such as in accordance with the mLDP process 249, which may contain computer executable instructions executed by the processor 220 (or independent processor of interfaces 210) to perform functions relating to the techniques described herein, e.g., in conjunction with routing process 244 (and/or BGP process 247). For example, the techniques herein may be treated as extensions to conventional protocols, and as such, may he processed by similar components understood in the art that execute those protocols, accordingly.

Operationally, a receiver PE that determines and stores BGP primary and backup recursive next hop information (e.g., in an RIB) may also send FEC requests towards both recursive next hops, thereby forming dual PIMP LSPs from a source PE back to the receiver PE. For example, as shown in FIG. 3C, PE1 may identity paths P1 and P2 via 3107 PIC and send requests 308 (e.g., recursive FEC requests) towards PE2 using both primary path P1 and backup path P2. In various embodiments, PE1 may mark the request 308 sent along path P1 as ‘Active’ and the request 308 sent along path P2 as ‘Inactive.’ In response to receiving requests 308, PE1 may then establish PIMP LSPs to FBI along both paths P1 and P2, as illustrated in FIG. 3D.

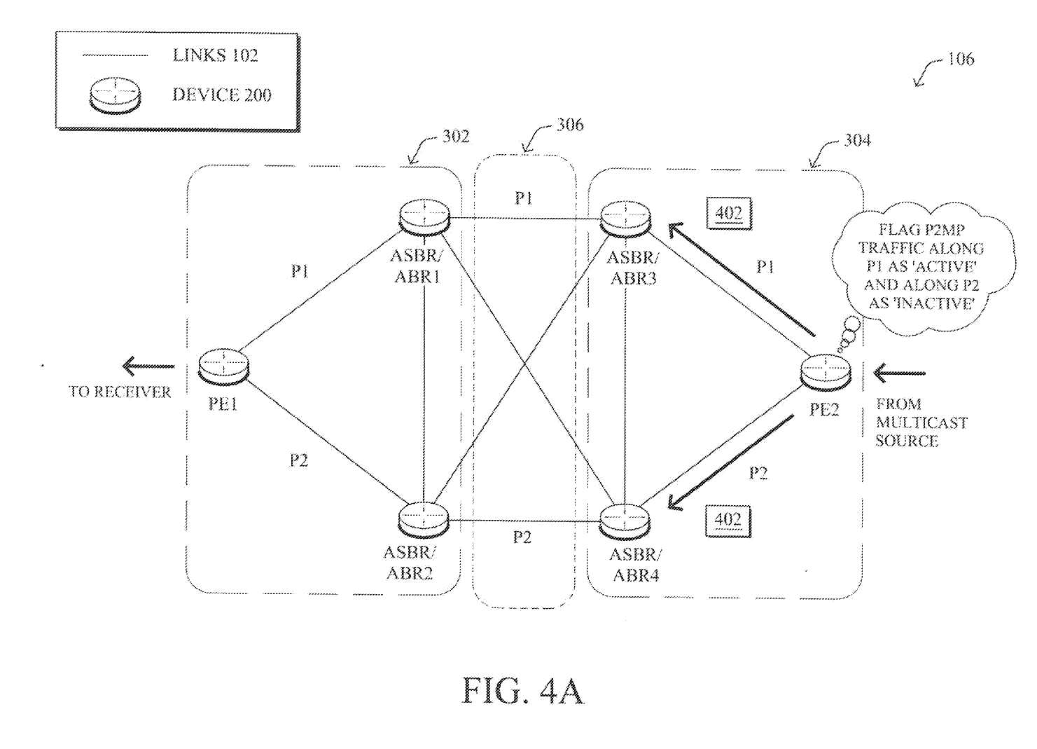

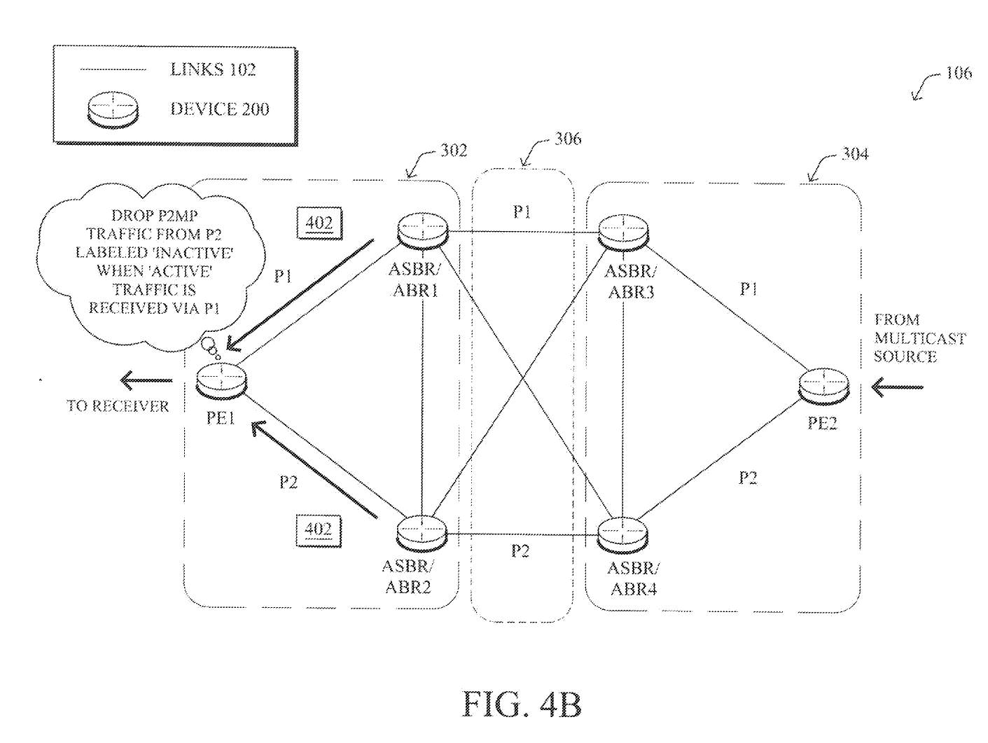

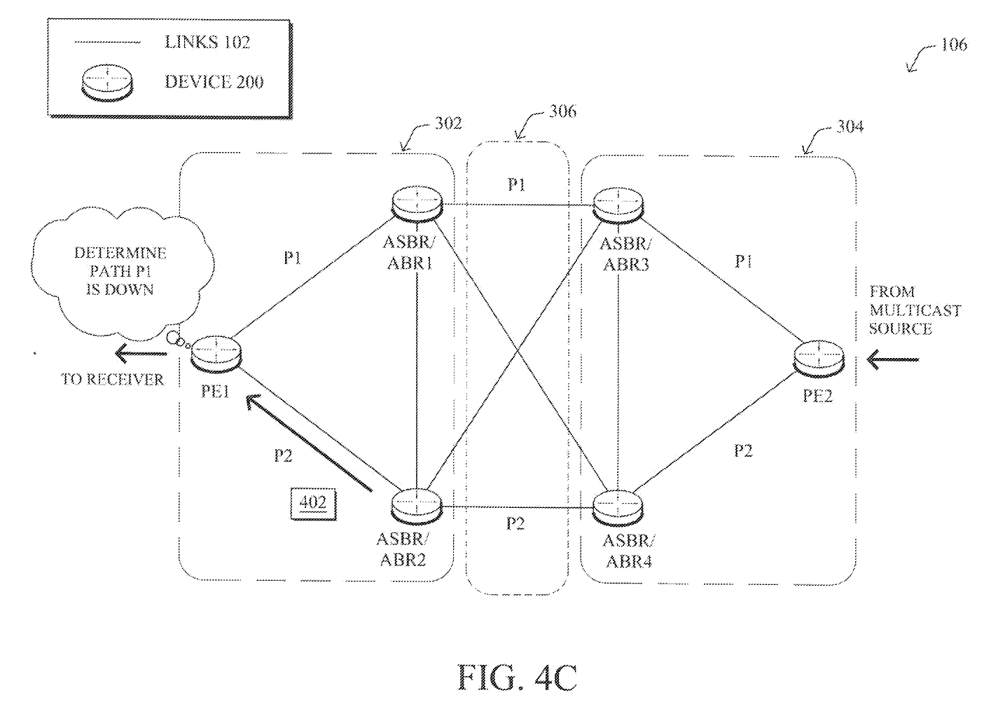

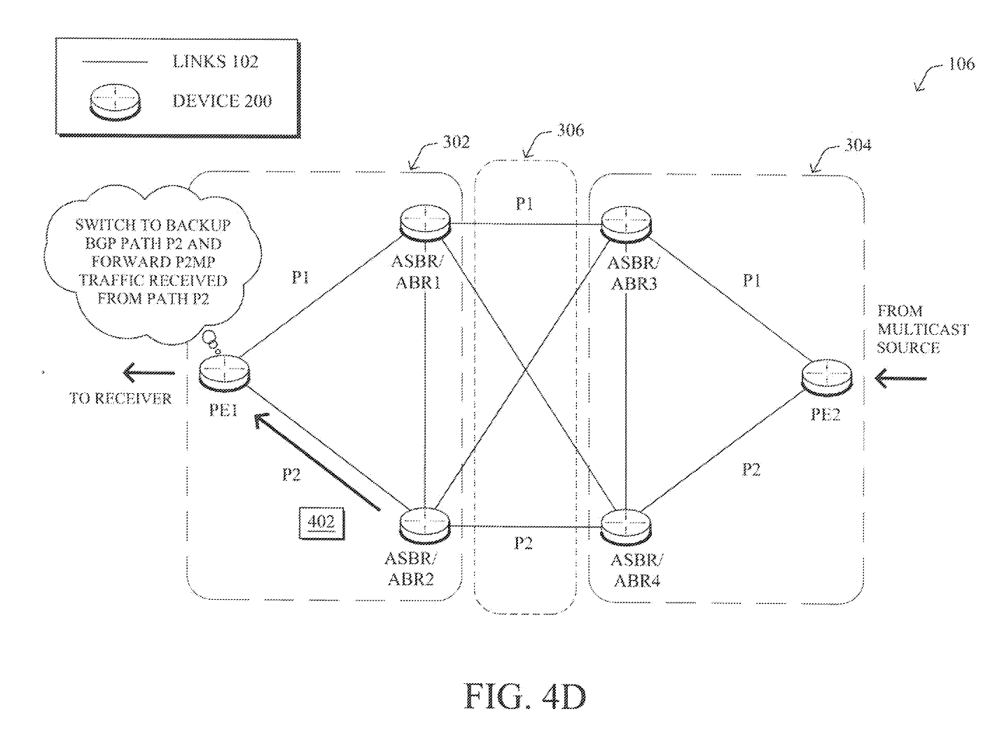

Referring now to FIGS. 4A-4D, an example of a network device switching between mLDP paths is shown, according to various embodiments. As shown in FIG. 4A, source PE2 may send multicast traffic 402 along both P2MP LSPs that correspond to paths P1 and P2. In some embodiments, source PE2 may flag or otherwise mark traffic 402 sent along path P1 as ‘Active’ and traffic 402 sent along path P2 as ‘Inactive’ (e.g., by setting a drop bit, etc.).

In response to receiving multicast traffic 402, the receiver PE1 may then analyze traffic 402, to identify whether the corresponding traffic was marked as ‘Active’ or ‘Inactive’ by PE1. If for example, PE1 receives multicast traffic 402 from both, paths P1. and P2, it may drop the P2MP traffic received via path P1 and marked ‘Inactive,’ as shown in FIG. 4B. In other words, PE1 may only forward traffic 402 to the destination device received via the primary path P1, while preventing duplicate transmission of the traffic 402 received via the secondary path P2.

As shown in FIG. 4C, assume that the primary recursive next hop ASBR/ABR1 goes down, at some time in the future. Consequently, PE1 may only receive the multicast traffic 402 via path P1. According to various embodiments, PE1 may be configured to trigger an immediate switchover of the backup PIMP LSP (e.g., along path P2) to being the active multicast LSP. In such a case, as shown in FIG. 4D, PE1 may immediately begin forwarding the P2MP traffic 402 received via path P2 to the destination device, in response to determining that the primary path P1 is down. Notably, such a switchover may also coincide with a BGP switchover from path P1 as the primary BGP path to using the backup BGP path P2. In some embodiments, the switchover to the inactive P2MP LSP may be based on existing BGP PIC triggers used by the device to determine when to switch from the primary BGP path to the backup BGP path.

When the original primary recursive next hop ASBR/ABR1 recovers, PE1 may employ a make before break (MBB) mechanism, before switching back to using the recovered path. For example, PE1 may wait for the primary recursive FEC LSP to be built up, before switching recursive FEC LSPs and making the primary recursive FEC LSP active again.

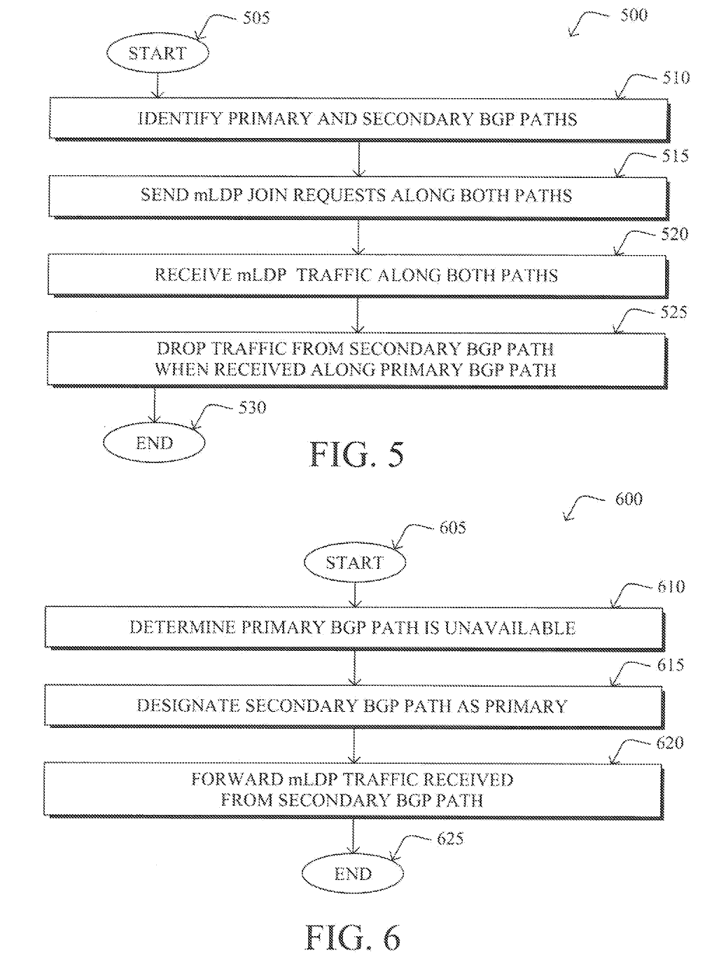

FIG. 5 illustrates an example simplified procedure for establishing primary and secondary network paths, in accordance with one or more embodiments described herein. The procedure 500 may start at step 505, and continues to step 510, where, as described in greater detail above, a network device/node (e.g., device 200 shown in FIG. 2) may identity primary and secondary BGP paths. For example, a device that implements 3107 PIC may Identify a primary and a backup BGP path and store information regarding both paths in its RIB. Notably, the device may be configured to switch between BGP paths, in response to determining that the primary BGP path is unavailable.

At step 515, the device sends mLDP join requests along both BGP paths, as described in greater detail above. For example, a PE router associated, with a destination of P2MP traffic may request to join the corresponding P2MP LSP via both the primary BGP path and the backup BGP path, in contrast to existing techniques. In some cases, the requests may explicitly identify the primary path as ‘Active’ and/or the backup path, as ‘Inactive.’

At step 520, the device receives mLDP traffic along both paths/LSPs established in response to sending the join requests in step 515, as detailed above. In various embodiments, the traffic received along the primary BGP path may be marked as ‘Active’ and/or the traffic received along the backup BGP path may be marked as ‘Inactive.’ For example, the mLDP traffic received along the backup BGP path may include a flag (e.g., a drop bit or other parameter) that signifies to the device that the mLDP traffic is inactive or otherwise redundant.

At step 525, as described in greater detail above, the device drops the mLDP traffic received along the backup (e.g., secondary) BGP path, when the traffic is also received along the primary BGP path. In various embodiments, dropping the traffic may entail only forwarding the mLDP traffic received via the primary BGP path, thereby leaving the mLDP traffic received from the secondary path unforwarded. Procedure 500 then ends at step 530.

FIG. 6 illustrates an example simplified procedure for switching network paths, in accordance with the embodiments described herein. The procedure 600 may start at step 605, and continues to step 610, where, as described in greater detail above, a network device/node (e.g., device 200 shown in FIG. 2) may determine that a primary BGP path is unavailable. For example, the device may use a 3107 PIC mechanism, to determine when the primary BGP path is unavailable.

At step 615, as detailed above, the device designates a secondary BGP path as a primary path. Notably, 3107 PIC and similar mechanisms may be used to determine both a primary and a secondary/backup BGP path. When the primary BGP path is unavailable, the device may seamlessly switch to using the secondary/backup BGP path.

At step 620, the device forwards mLDP traffic received from the secondary BGP path on to a destination device, as described in greater detail above. In various embodiments, such as those implementations in accordance with procedure 500, the device may receive traffic belonging to the same multicast along both the primary BGP path and along the secondary BGP path. For example, the device may send recursive FEC messages along both BGP paths, to establish different LSPs for the multicast traffic. When the device receives the mLDP traffic along both paths, the device may drop the traffic received along the secondary/backup path. However, in response to detecting that the primary BGP path is no longer available (e.g., In response to a 3107 PIC path switchover/fast reroute being triggered), the device may begin forwarding the multicast traffic received along the secondary/backup path to the destination device. Procedure 600 then ends at step 625.

It should be noted that while certain steps within, procedures 500-600 may be optional as described above, the steps shown in FIGS. 5-6 are merely examples tor illustration, and certain other steps may be included or excluded as desired. Further, while a particular order of the steps is shown, this ordering is merely illustrative, and any suitable arrangement of the steps may be utilized, without departing from the scope of the embodiments herein. Moreover, while procedures 500-600 are described separately, certain steps from each procedure may be incorporated into each other procedure, and the procedures are not meant to he mutually exclusive.

The techniques described herein, therefore, provide for establishing an mLDP backup path. In particular, the techniques herein allow a device to pre-establish an inactive recursive FEC LSP along a BGP backup path, in addition to establishing an active recursive FEC LSP along the primary BGP path. Thus, if the primary BGP path fails, the device may seamlessly transition between the paths and continue to forward the multicast traffic (e.g., as part of a MoFRR mechanism). Doing so may minimize traffic loss, in contrast to existing techniques that would require the device to establish a new LSP after the primary BGP path goes down.

While there have been shown and described illustrative embodiments that provide for establishing a backup mLDP path in a network, it is to be understood that various other adaptations and modifications may be made within the spirit and scope of the embodiments herein. For example, while certain protocols are shown, such as 3107 PIC, other suitable protocols may be used, accordingly. Also, while the techniques generally describe processes that may be implemented by a PE router, other network devices may also be used to implement the functions described herein.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium, (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
determining, by a first device in a network, a primary border gateway protocol (BGP) path and a secondary BGP path to a second device In the network;
sending, by the first device, requests to join a multicast label switched path (LSP) to the second device via the primary BGP path and via the secondary BGP path;
receiving, at the first device, LSP traffic associated with the multicast LSP via the primary and secondary BGP paths; and
dropping, by the first device, the LSP traffic received via the secondary BGP path, in response to receiving the LSP traffic via the primary BGP path.

2. The method as in claim 1, further comprising:
determining, by the first device, that the primary BGP path is unavailable; and
forwarding, by the first device, LSP traffic associated with the multicast LSP received via the secondary BGP path designated as a primary BGP path, in response to determining that the primary BGP path is unavailable.

3. The method as in claim 2, further comprising:
determining, by the first device, that the primary BGP path is available after being unavailable; and
performing, by the first device, a make or break handoff to begin forwarding LSP traffic received via the primary BGP path and dropping LSP traffic received via the secondary BGP path.

4. The method as in claim 2, further comprising:
designating, by the first device, the secondary BGP path as a primary BGP path, in response to determining that the primary BGP path is unavailable.

5. The method as in claim 1, wherein the LSP traffic received via the secondary BGP path is flagged as inactive and the LSP traffic received via the primary BGP path is flagged as active.

6. The method as in claim 1, wherein determining the primary BGP path and the secondary BGP path comprises:
identifying, by the first device, a primary recursive next hop router and a secondary recursive next hop router.

7. The method as in claim 6, wherein the primary and secondary recursive next hop routers are autonomous system boundary routers.

8. An apparatus, comprising:
one or more network interfaces to communicate with a computer network;
a processor coupled to the one or more network interfaces and configured to execute one or more processes; and
a memory configured to store a process executable by the processor, the process when executed operable to:
determine a primary border gateway protocol (BGP) path and a secondary BGP path to a remote device in the network;
send requests to join a multicast label switched path (LSP) to the remote device via the primary BGP path and via the secondary BGP path;
receive LSP traffic associated with the multicast LSP via the primary and secondary BGP paths; and
drop the LSP traffic received via the secondary BGP path, in response to receiving the LSP traffic via the primary BGP path.

9. The apparatus as in claim 8, wherein the process when executed is further operable to:
determine that the primary BGP path is unavailable; and
forward LSP traffic associated with she multicast LSP received via the secondary BGP path designated as a primary BGP path, in response to determining that the primary BGP path is unavailable.

10. The apparatus as in claim 9, wherein the process when executed is further operable to:
determine that the primary BGP path is available after being unavailable; and
perform a make or break handoff to begin forwarding LSP traffic received via the primary BGP path and dropping LSP traffic received via the secondary BGP path.

11. The apparatus as in claim 9, wherein the process when executed is further operable to:
designate the secondary BGP path as a primary BGP path, in response to determining that the primary BGP path is unavailable.

12. The apparatus as in claim 8, wherein the LSP traffic received via the secondary BGP path is flagged as inactive and the LSP traffic received via the primary BGP path is flagged as active.

13. The apparatus as in claim 12, wherein the primary BGP path and the secondary BGP path are determined by:
identifying a primary recursive next hop router and a secondary recursive next hop router.

14. The apparatus as in claim 13, wherein the primary and secondary recursive next hop routers are autonomous system boundary routers.

15. A tangible, non-transitory, computer-readable media having software encoded thereon, the software when executed by a processor on a device in a computer network operable to:
determine a primary border gateway protocol (BGP) path and a secondary BGP path to a remote device in the network;
send requests to join a multicast label switched path (LSP) to the remote device via the primary BGP path and via the secondary BGP path;
receive LSP traffic associated with the multicast LSP via the primary and secondary BGP paths; and
drop the LSP traffic received via the secondary BGP path, in response to receiving the LSP traffic via the primary BGP path.

16. The computer-readable media as in claim 15, wherein the software when executed is further operable to:
determine that the primary BGP path is unavailable; and
forward LSP traffic associated with the multicast LSP received via the secondary BGP path designated as a primary BGP path, in response to determining that the primary BGP path is unavailable.

17. The computer-readable media as in claim 16, wherein the software when executed is further operable to:
determine that the primary BGP path is available after being unavailable; and
perform a make or break handoff to begin forwarding LSP traffic received via the primary BGP path and dropping LSP traffic received via the secondary BGP path.

18. The computer-readable media as in claim 16, wherein the software when executed is farther operable to:
designate the secondary BGP path as a primary BGP path, in response to determining that the primary BGP path is unavailable.

19. The computer-readable media as in claim 15, wherein the LSP traffic received via the secondary BOP path is flagged as inactive and the LSP traffic received via the primary BGP path is flagged as active.

20. The computer-readable media as in claim 15, wherein the primary BGP path and the secondary BGP path are determined by:
identifying a primary recursive next hop router and a secondary recursive next hop router.
